(19) United States
(12) Patent Application Publication
(10) Pub. No.: US 2023/0150544 A1
(43) Pub. Date: May 18, 2023

(54) GENERATING NOTIFICATIONS INDICATIVE OF UNANTICIPATED ACTIONS

(71) Applicant: Motional AD LLC, Boston, MA (US)

(72) Inventors: Bence Cserna, East Boston, MA (US); Laith Sahawneh, Murrysville, PA (US)

(21) Appl. No.: 17/989,065

(22) Filed: Nov. 17, 2022

Related U.S. Application Data
(60) Provisional application No. 63/281,033, filed on Nov. 18, 2021.

(51) Int. Cl. B60W 60/00; B60W 30/09; B60Q 9/00

(52) U.S. Cl. CPC B60W 60/0016; B60W 30/09; B60Q 9/008

(57) ABSTRACT

Provided are methods for generating notifications indicative of unanticipated actions. Data associated with a current trajectory of an autonomous vehicle, at least one constraint, data associated with historical data for a user using the autonomous vehicle from an expectation database, and data associated with a context that represents a relationship between the current trajectory, at least one constraint, and historical driving data is received. A model is deployed to determine, in real-time and based on the current trajectory, the at least one constraint, and the data associated with the context that a particular action by the autonomous vehicle is classified as an unanticipated autonomous vehicle action. The current trajectory, the at least one constraint, and the data associated with the context are analyzed within a predetermined range of time including a timestamp of the unanticipated autonomous vehicle action to determine a reason for occurrence of the unanticipated autonomous vehicle action. A notification is generated that includes the reason, wherein an intensity of the notification is based on, at least in part, the deviation.

### CROSS-REFERENCE TO RELATED APPLICATIONS

This application claims priority to U.S. Provisional Application No. 63/281,033, filed Nov. 18, 2021, the entire contents of which are incorporated herein by reference.

### BACKGROUND

Autonomous vehicles observe an environment through sensors, systems, devices that capture information in the environment. Autonomous vehicles navigate through the environment with varying levels of human input.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 is a diagram of an implementation of a process for generating notifications indicative of unanticipated actions;

FIG. 6 is a flowchart of a process for generating notifications indicative of unanticipated actions;

FIG. 7A is a diagram of an example of an architecture for generating notifications indicative of unanticipated actions;

FIG. 7B shows a notification;

FIG. 7C shows another notification;

FIG. 8 is a process flow diagram of a process for generating notifications indicative of unanticipated actions;

FIG. 9 is a block diagram of an architecture for notification generation according to the present techniques; and

FIG. 10 is a process flow diagram of a process for outputting notifications and updating user preferences according to the present techniques.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

General Overview

In some aspects and/or embodiments, systems, methods, and computer program products described herein include and/or generate notifications indicative of unanticipated actions. For example, a vehicle (such as an autonomous vehicle) generates real-time notifications explaining reasoning (e.g., one or more causes) for its unanticipated actions to passengers of the vehicle or other individuals in the vicinity of the vehicle. In examples, unanticipated actions are executed in response to unexpected events. For example, an unexpected event is a pedestrian unexpectedly rushing into the lane in which the vehicle is traveling, and an exemplary unanticipated action is the vehicle suddenly changing lanes in response to the pedestrian rushing into the lane. Notifications are generated based on a user profile of at least one passenger (e.g., a user). In examples, the profile includes historical driving data associated with the at least one passenger and notification preferences specified by the at least one passenger.

The notifications communicate the reasoning for unanticipated actions. In examples, the reasoning is communicated to one or more passengers within the vehicle, other drivers in vehicles in the vicinity of the vehicle during the unanticipated event, or other agents in the environment. The communication increases a confidence of the one or more passengers within the vehicle, other drivers in vehicles in the vicinity of the vehicle during the unanticipated event, or other agents in the environment. In some embodiments, an explainability system is communicatively coupled to, but separate from, a planning system. Separation between the explainability system and planning system enables the planning system to perform operations without performing the explainability operations (e.g. generation of notifications that include an explanation or reasoning of the unanticipated vehicle action), which could otherwise slow the operations performed by the planning system. The explainability aspects being performed by a separate explainability system thus eliminates impacts on latency, which enables the notifications to be generated in real-time with little or no latency. The real time generation of notifications in turn enhances the confidence agents have in the vehicle. Additionally, the generation and/or output of notifications are advantageously customized for each individual (e.g. passenger) based on a driving history associated with the individual and user preferences specified by the individual, thereby enabling the data generated to be more accurately tied to the individual. In an embodiment, the explainability system generates real-time notifications when both of an event and the vehicle's corresponding action are unanticipated by an agent that receives communications from the vehicle (e.g. passenger), which prevents constant generation of notifications. In this manner, bandwidth is preserved and optimized. Additionally, the use of computing resources such as processors, memory, and database storage is also preserved and optimized.

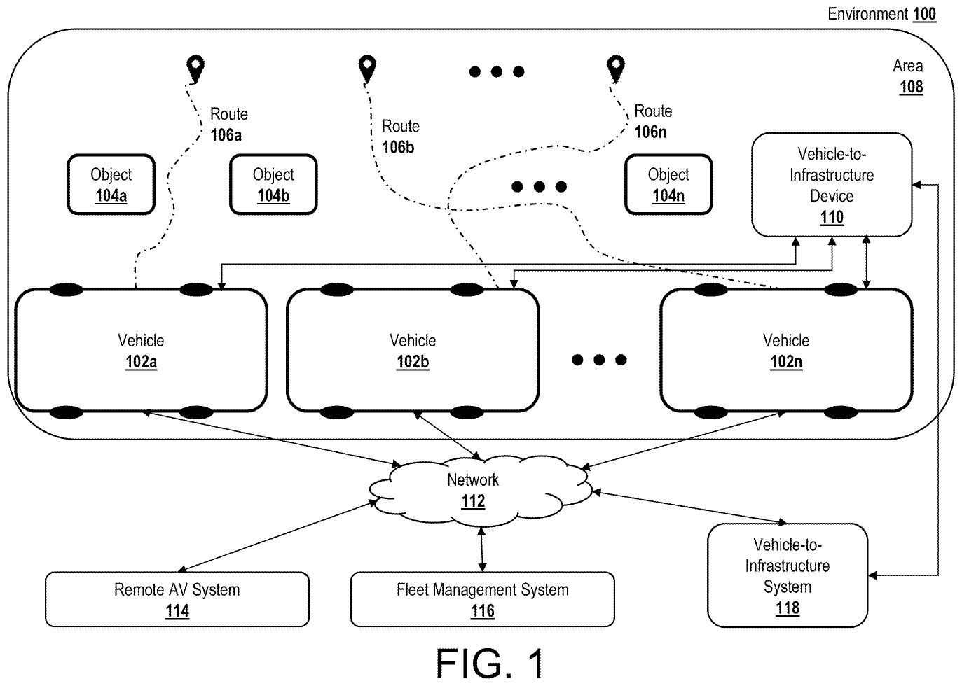

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

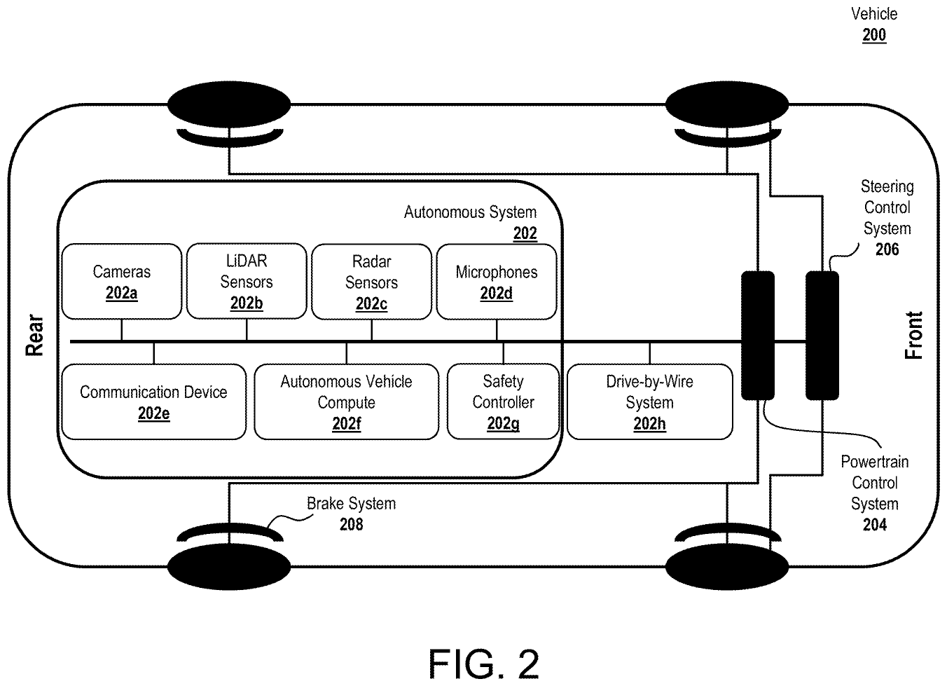

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

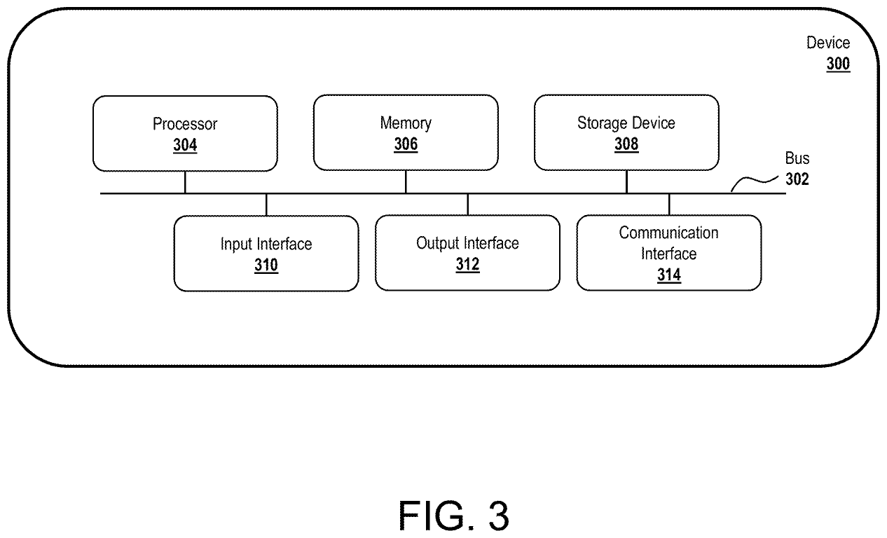

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device configured to generate notifications of unexplained actions, and/or one or more devices of network 112 (e.g., one or more devices of a system of network 112). In some embodiments, one or more devices of vehicles 102 (e.g., one or more devices of a system of vehicles 102), one or more devices configured to generate notifications of unexplained actions, and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

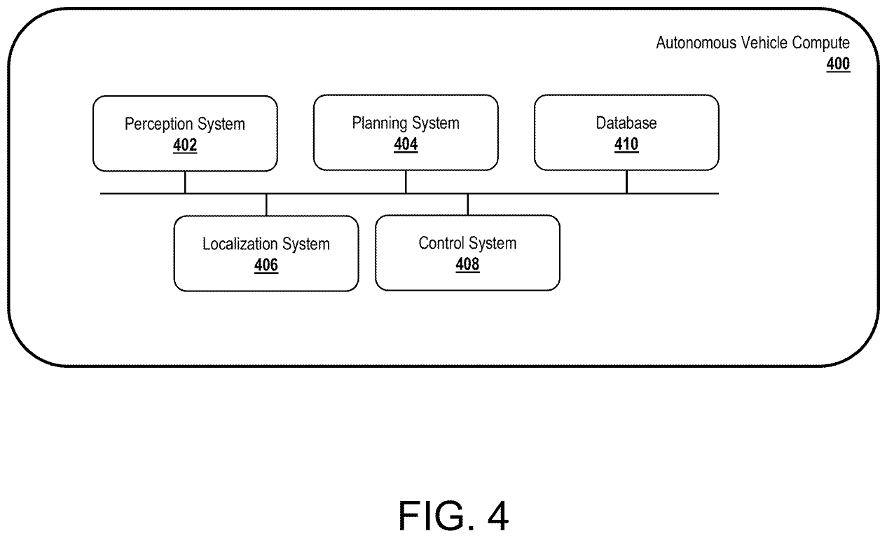

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments, perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits [ASICs], Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

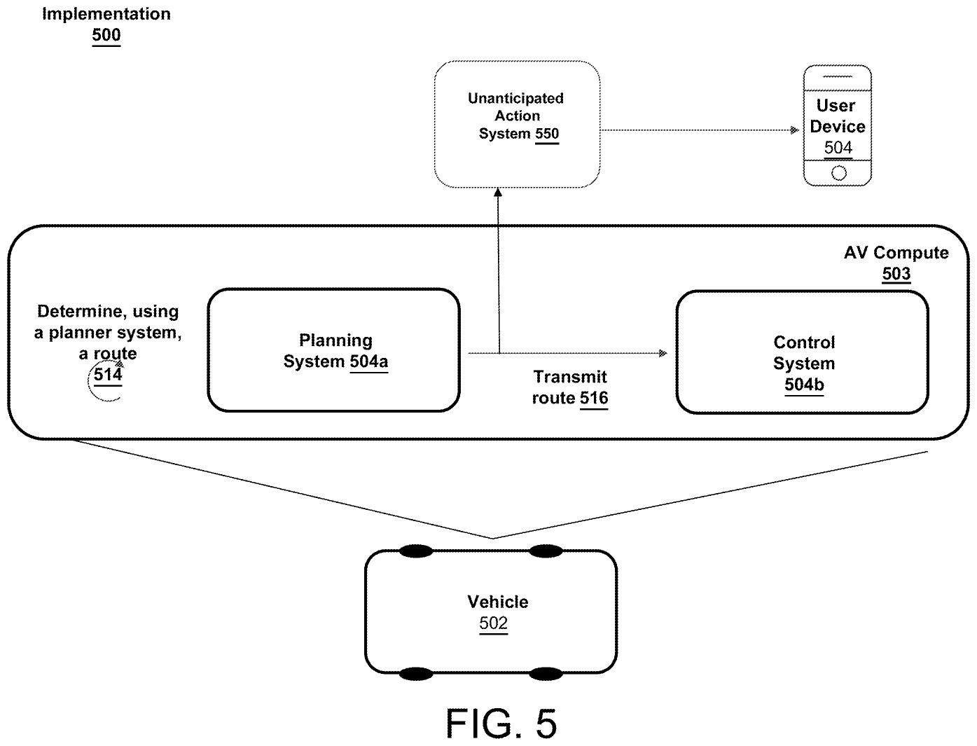

Referring now to FIG. 5, illustrated are diagrams of an implementation 500 of a process for generating notifications indicative of unanticipated actions. In some embodiments, implementation 500 includes an unanticipated action system 550. In some embodiments, the unanticipated action system 550 generates real-time notifications that provide reasons for unanticipated actions. In examples, the unanticipated actions are actions performed by the vehicle in response to unexpected events. The actions are unanticipated by passengers of the vehicle, other individuals in the vicinity of the vehicle, other vehicles in the vicinity of the vehicle, and any combinations thereof. In examples, an unanticipated action is an action taken by the autonomous vehicle that deviates from a planned action, such as a trajectory or planned path output by a planning system 504a. In some embodiments, an unanticipated action is an action that deviates from an agent's (e.g., passenger, pedestrian, cyclist, other vehicle) expectations. For example, the unanticipated action is an action that deviates from the expectations of a passenger within the vehicle cabin.

In examples, the unanticipated action system 550 receives routes that are transmitted (516) from the planning system 504a to the control system 504b of an AV compute 503. The planning system 504a is the same as or similar to planning system 404 of FIG. 4. Similarly, the control system 504b is the same as or similar to control system 408 of FIG. 4, and the AV compute 503 is the same as or similar to the AV compute 400 of FIG. 4. The control system 504b receives data associated with at least one trajectory from planning system 504a and control system 504b controls operation of the vehicle. In some embodiments, the unanticipated action system 550 receives data associated with at least one trajectory from planning system 504a and generates notifications in response to unanticipated actions using one or more pre-trained models. In examples, the notifications are real-time notifications that are rendered for via a user device 504. In some cases, the real-time notifications are rendered for the passenger via systems of the vehicle 502.

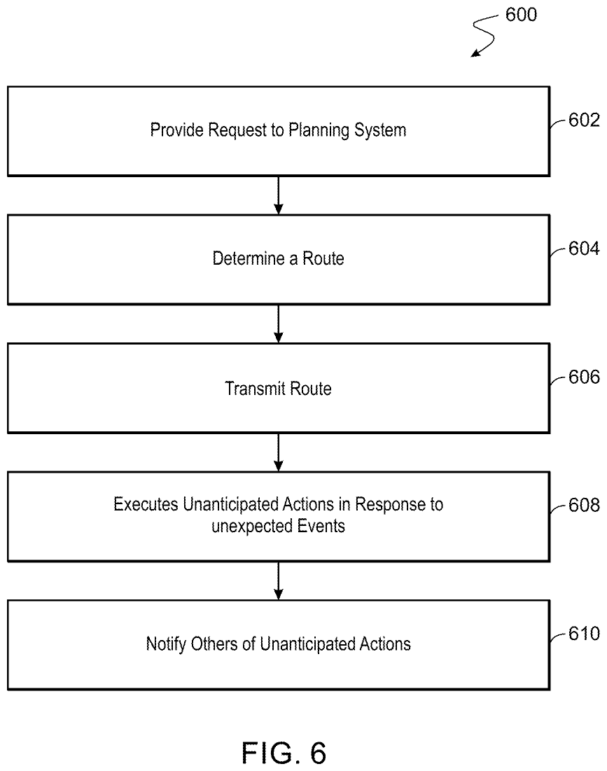

Referring now to FIG. 6, illustrated is a flowchart of a process 600 for generating notifications indicative of unanticipated actions. In some embodiments, one or more of the elements described with respect to process 600 are performed (e.g., completely, partially, and/or the like) by vehicle 102 (FIG. 1), autonomous system 202 (FIG. 2), or any combinations thereof. Additionally, or alternatively, in some embodiments one or more steps described with respect to process 600 are performed (e.g., completely, partially, and/or the like) by another device or group of devices separate from or including autonomous system 202, such as unanticipated action system 550. In an embodiment, the present techniques receive, from a planning system, a current trajectory, context data, and constraints. A notification is generated is response to the unanticipated action. Notifications are transmitted to communicate at least one explanation for the unanticipated action.

In the example of FIG. 6, at block 602 a request for trajectory data, context data, and constraints is obtained. The trajectory data, context data, and constraints are obtained from an autonomous system, such as the autonomous system 202 of FIG. 2. In examples, the trajectory data, context data, and constraints are obtaining from a planning system, such as the planning system 404 of FIG. 4 or the planning system 504a of FIG. 5. At block 604, a route is determined. In some embodiments, the route is determined based on currently available, real time data captured by sensors of an AV (e.g., cameras 202a, LiDAR sensors 202b, radar sensors 202c, and microphones 202d of FIG. 2). At block 606, the determined route is transmitted. In some embodiments, the determined route is transmitted to a control system (e.g., 408 of FIG. 4, 504b of FIG. 5). In some embodiments, the determined route is based on one or more calculations or predictions made by the AV stack.

At block 608, unanticipated actions are executed in response to unexpected events. For example, a pedestrian entering the AVs planned path of travel as generated by the planning system is an unexpected event. In response to the unexpected event, the AV executes one or more unanticipated actions. For example, the AV modifies a planned path of travel in response to a pedestrian entering the planned path of travel. At block 610, the vehicle notifies others of the unanticipated actions. For example, the AV can provide a passenger with a notification that an unanticipated action has occurred and an explanation of the unanticipated action.

While riding in an AV, passengers are exposed to the consequences of the decisions made by the vehicle's planning system (e.g., planning system 404 of FIG. 4). To improve the trust and confidence of the passengers in the vehicle, the vehicle should conform to behavioral expectations of the passengers. For example, the vehicle should avoid sudden movements and deviations from planned routes. However, in some cases the AV has to deviate from such expectations due to safety and performance reasons. The present techniques provide explainable feedback to the passengers when the deviation occurs to improve comfort and prevent user circumvention.

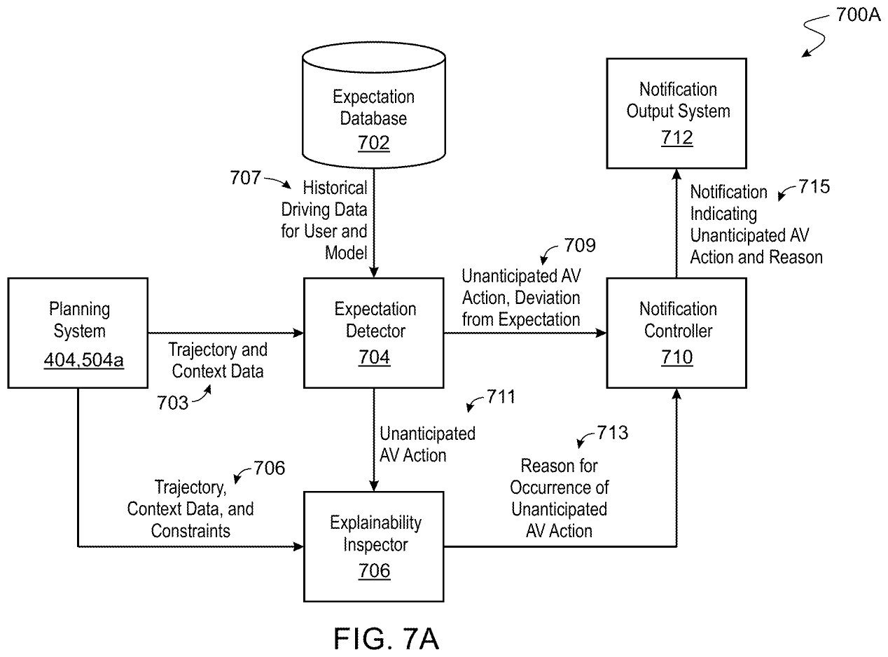

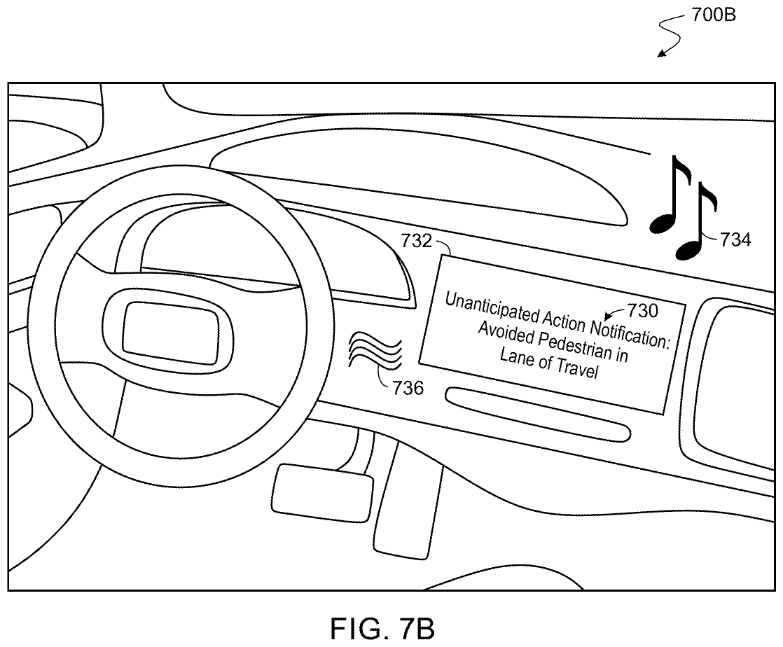

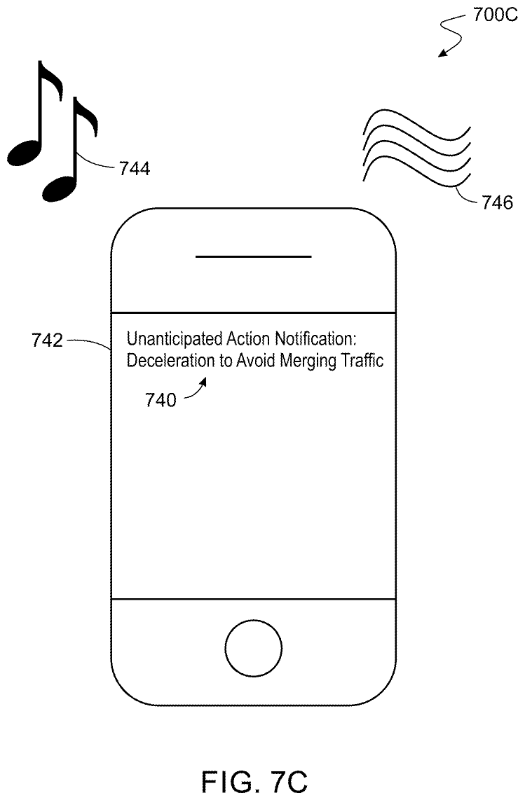

FIG. 7A is a block diagram of an architecture 700A for generating notifications indicative of unanticipated actions. The architecture 700A includes an expectation database 702, an expectation detector 704, and an explainability inspector 706.

In the example of FIG. 7A, a planning system such as the planning system 404 (FIG. 4) or the planning system 504a (FIG. 5) outputs trajectory and context data 703 that is input to an expectation detector 704. In examples, context data includes a semantic map, localization data, and perception data. An expectation database 702 stores historical driving data associated with a user and one or more models. In some embodiments, the models are machine learning models that characterize one or more actions of the AV. In examples, a machine learning model is trained at a cloud computing system communicatively coupled to the autonomous vehicle. The trained machine learning model outputs unanticipated AV actions. For example, the at least one model is trained to output unanticipated AV actions based on user preferences. A user profile includes preference data. In examples, the preference data is obtained directly from the at least one passenger. In examples, the preference data is based on the historical driving data associated with the passenger. Additionally, in examples the preference data is based on historical driving data of previous passengers that share similar characteristics as a current passenger. In examples, similar characteristics include a same age, height, weight, or other physical characteristics.

The historical driving data associated with a passenger and one or more models (707) are input to the expectation detector 704. In examples, the expectation detector 704 obtains trajectory data, context data (703), historical driving data associated with a passenger, and one or more models that characterize actions of an AV (707). The expectation detector 704 outputs an unanticipated action that is a deviation from expectations (709) by executing the model with trajectory data, context data, and historical driving data of a passenger as inputs.

The planning system 404, 504a outputs trajectory data, context data, and constraints (705) that are input to an explainability inspector 706. Examples of constraints include road features (e.g. objects), other road users (e.g. pedestrians, other drivers), and other agents in the environment. The unanticipated AV action (711) that is a deviation from expectations as output by the expectation detector 704 is input to the explainability inspector 706. The explainability inspector 706 outputs a reason for the occurrence of the unanticipated AV action (713).

A notification controller 710 obtains as input the unanticipated action that is a deviation from expectations (709) as output by the expectation detector 704 and the reason for the occurrence of the unanticipated AV action (713) as output by the explainability inspector 706. The notification controller outputs one or more notifications indicating an unanticipated action and at least one reason associated with the unanticipated action (715). A notification output system 712 obtains as input a notification indicating unanticipated action and reason (715) from the notification controller 710. In some embodiments, the notification output system 712 outputs a notification indicating unanticipated action and reason to one or more passengers as described with respect to FIGS. 7B and 7C.

FIG. 7B shows an exemplary notification 730. As illustrated, the notification 730 is rendered on a display 732. The exemplary notification 730 is text based, and reads “Unanticipated Action Notification: Avoided pedestrian in lane of travel.” In this example, the an unexpected event is a pedestrian unexpectedly rushing into the lane in which the vehicle is traveling, and an exemplary unanticipated action is the vehicle suddenly changing lanes in response to the pedestrian rushing into the lane. The exemplary notification 730 provides a cause (e.g., a pedestrian unexpectedly rushing into the lane in which the vehicle is traveling). For ease of illustration, the notification 730 is illustrated as text. However, a notification according to the present techniques can be an image, haptic feedback, video, text, or audio that communicates a notification indicating unanticipated action and reason to one or more passengers. In the example of FIG. 7B, a notification output system can also output audio 734 that communicates a notification. For example, the audio 734 includes a digital voice that speaks the notification. In examples, the notification output system causes vibrations 736 as part of the notification. Additionally, in examples lighting or other visual cues are used to signal an unexpected action. For example, a notification can include flickering or pulsing of lighting at the AV, or changing color of the lighting.

FIG. 7C shows a notification 740. As illustrated, the notification 740 is rendered on a display 742 of a user device 700C. The exemplary notification 740 is text based, and reads “Unanticipated Action Notification: Deceleration to Avoid Merging Traffic.” In this example, an unexpected event is traffic merging into a single lane in which the vehicle is traveling, and the unanticipated action is the vehicle suddenly decelerating in response to the another vehicle merging into the lane. The exemplary notification 740 provides a cause. In this example, a cause may be a vehicle entering the lane in which the vehicle is traveling, typically without using a blinker or other signal. For example, a vehicle can unexpectedly merge or swerve into the lane occupied by the AV. For ease of illustration, the notification 740 is illustrated as text. However, a notification according to the present techniques can be an image, haptic feedback, video, text, or audio that communicates a notification indicating unanticipated action and reason to one or more passengers. In the example of FIG. 7C, a notification output system can also output audio 744 that communicates a notification. For example, the audio 744 includes a digital voice that speaks the notification. In examples, the notification output system causes vibrations 746 as part of the notification.

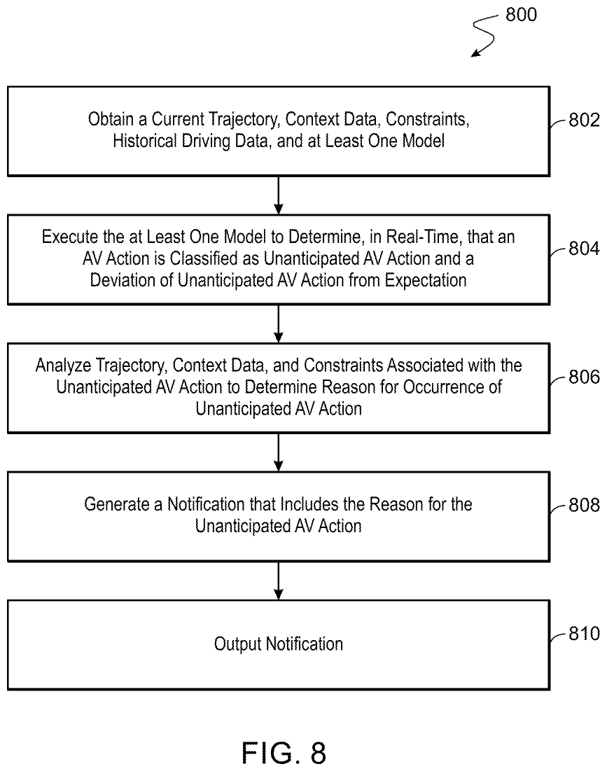

FIG. 8 is a process flow diagram of a process 800 for generating notifications indicative of unanticipated actions. In some embodiments, one or more of the elements described with respect to process 800 are performed (e.g., completely, partially, and/or the like) by vehicle 102 (FIG. 1), autonomous system 202 (FIG. 2), or any combinations thereof. Additionally, or alternatively, in some embodiments one or more steps described with respect to process 800 are performed (e.g., completely, partially, and/or the like) by another device or group of devices separate from or including autonomous system 202, such as unanticipated action system 550.

In the example of FIG. 8, at block 802 a current trajectory, context data, constraints, historical driving data for a passenger, and at least one model are obtained. In some embodiments, the current trajectory and context data are generated by a planning system of the AV. Additionally, in some embodiments, the historical driving data and at least one model are obtained from an expectation database (e.g., expectation database 702 of FIG. 7A). In examples, the at least one model is a model trained to output unanticipated AV actions.

At block 804, the at least one model is executed to determine, in real time and based on other received data, a classification of actions executed by the AV. In examples, the classification determines if the AV action is an unanticipated action or an anticipated action. In examples, the model is executed to determine if a deviation from an expected vehicle action has occurred, creating an unanticipated action. For example, the planning system generates a route that is obtained by the unanticipated action system. Data associated with the route is input to the at least one model to classify current actions executed, performed, or output by the AV. In some embodiments, an action is classified as an unanticipated action based on the current trajectory, at least one constraint, and context data.

In examples, context data provides context associated with where the AV is going (e.g., the route, including an initial state, a final goal state, and/or a goal region), the passengers that ride in the AV, etc. In examples, context data includes a semantic map, localization data, and perception data. For example, a semantic map enables an understanding of the vehicle's actions based on, at least in part, map data. In examples, localization data is used to determine that a particular action by the autonomous vehicle is classified as an unanticipated autonomous vehicle action based on a deviation in the current localization data when compared to expected localization data values. For example, a discrepancy between a current position of the vehicle as determined via the localization system (e.g., localization system 406) and an expected location of the vehicle indicates that a vehicle action is unexpected. In another example, perception data is used to determine that a particular action by the autonomous vehicle is classified as an unanticipated autonomous vehicle action based on a deviation in the current perception data when compared to expected perception data values. For example, a discrepancy between a current position of an object as determined via the perception system (e.g., perception system 402) and an expected location of the object indicates that a vehicle action is unexpected.

In examples, the model is a machine learning model, such as a (a) a linear regression model (e.g. a model that finds a line or curve that best fits the data), (b) a decision tree model (e.g. a model that has nodes, where the last nodes of the tree that are also referred to as leaves of the tree make decisions, where the number of nodes can be increased to enhance accuracy of the decision making and number of nodes can be decreased to enhance speed to reduce latency), (c) random forest model (e.g. model that involves creating multiple decision trees using bootstrapped datasets of the original data and randomly selecting a subset of variables at each step of the decision tree, where this model advantageously reduces the risk of error from an individual tree), (d) a neural network (e.g. a model that receives a vector of inputs, performs equations at various stages, and generates a vector of outputs), and/or the like. Additionally or alternatively, the model is an equation such as an if/then algorithm.

At block 806, the trajectory, context data, and constraints are analyzed in real time to determine a reason for occurrence of unanticipated action. In some embodiments, the data that is input to the model to determine the occurrence of an unexpected vehicle action is analyzed to determine a reason (e.g., cause) of the unanticipated action. In some embodiments, the information analyzed is within a predetermined range of time that includes a timestamp associated with the occurrence of the unanticipated action. In this manner, data corresponding to events that happen near the occurrence of the unanticipated action are analyzed to determine reasons for the unanticipated action. In some embodiments, the predetermined time range is iteratively increased, starting with a timestamp at or near the occurrence of the unanticipated action, until a reason for the unanticipated action is determined.

The unanticipated action represents a deviation from an expected action. In some cases, the expected action is an action expected by a typical passenger in an AV traveling at the current trajectory. In examples, the expected action is the same as or similar to the current trajectory of the AV. For example, the expected action is an action expected by the planning system of the AV traveling at the current trajectory. Thus, the “expected action” can be independent of the user. In alternate implementations, the expected action is based on a driving history associated with the user. In examples, the driving history is a record of a response of the passenger while being driven by one or more AVs. The driving history includes, for example, passenger response or feedback to AV actions during a drive, a passenger rating of a drive, biometric data captured during a drive, and the like. In some embodiments, the driving history is part of a user profile. In examples, the driving history is analyzed to determine the passenger's expectations with respect to travel in the AV.

At block 808, a notification is generated that includes a reason for the unanticipated AV action. In some embodiments, the notification is generated by a notification controller in response to receipt of the reason for occurrence of the unanticipated action. In examples, the notification includes an intensity associated with the unanticipated action. The intensity varies according to one or more of: the amount of information/data included within a notification, the frequency at which the notification is sent to the notification output system, the channel or mode by which the notification is transmitted, and the like. For example, notifications generated in response to a large quantity of information/data are more intense than notifications generated in response to less information/data. In examples, notifications generated at a higher frequency are more intense than notifications generated at a lower frequency.

At block 810, the notification is output. In examples, the notification is output by the notification output system. In some embodiments, the notification is transmitted to the notification output system via the notification controller. In some embodiments, data associated with the notification output system is configured to cause the notification output system to take certain actions based on receiving that data. In examples, the notification output system is a computer that outputs the notification as an audio or video, or a haptic feedback system that provides a haptic feedback as a notification. In some examples, the notification output system is configured to output notifications via social media, social media channels, email, personalized email, and Short Message Service (SMS) messaging (e.g., text messages). In an example, notifications output at a social media channel are less intense than notifications output to a personalized email or SMS messaging.

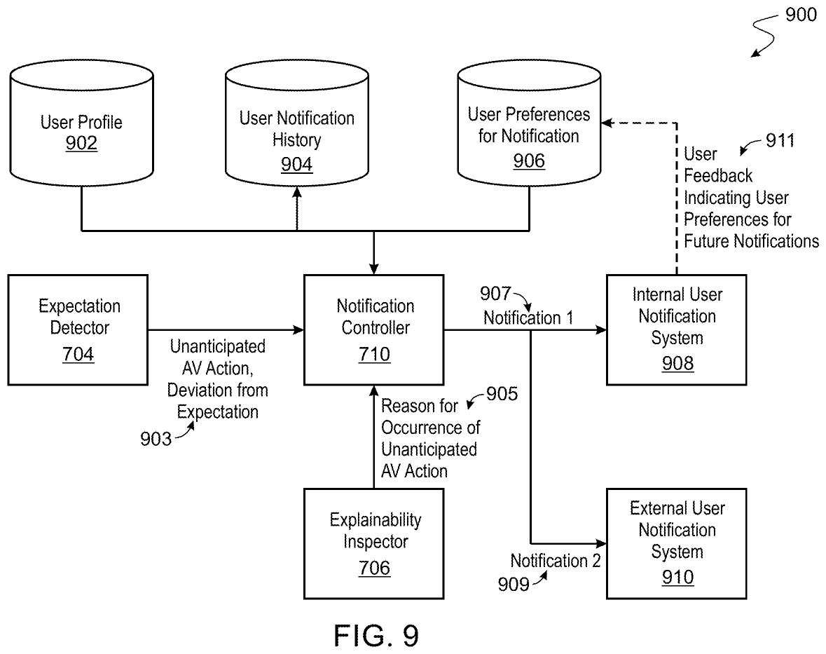

FIG. 9 is a block diagram of an architecture 900 for notification generation according to the present techniques. In the example of FIG. 9, the notification controller 710 corresponds to the notification controller 710 of FIG. 7A. The notification controller 710 takes as input a user profile 902, user notification history 904, and user preferences for notification 906. In some embodiments, a user profile is either existing or generated using classification techniques. The notification controller 710 also takes as input an unanticipated action (903). In some embodiments, the unanticipated action is a deviation from expectation as described above. The notification controller 710 also takes as input a reason for occurrence of the unanticipated action (905) from the explainability inspector 706.

The user profile 902 may be, for example, a record of a user that includes historical driving data associated with the user, a driving history associated with the user, and notification preferences specified by the user. In the example of FIG. 9, a user is a former, current, or future passenger in an AV. Thus, a user can establish a profile and set preferences before, during, or after traveling in an AV. Generally, the user profile includes information associated with the user that is a collection of settings and information that characterize the user expectations during travel (e.g., while being driven by an AV). In some embodiments, the notification controller 710 outputs a first notification (907) that is transmitted to an internal user notification system 908. In examples, the first notification includes user data that captures the user response within a predetermined range of time of the notification. The internal user notification system 908 outputs user feedback indicating user preferences for future notifications (911) that are stored at the user preferences for notification 906. In some embodiments, the notification controller 710 outputs a second notification (909) that is transmitted to an external user notification system 910, as described above. In an embodiment, the external user notification system 910 includes a user device (e.g., user device 504 of FIG. 5). The external user notification system 910 also includes input/output devices embedded within or associated with the AV (e.g., AV 102, vehicle 200). In examples, the external user notification system 910 renders an explanation of the unanticipated action.

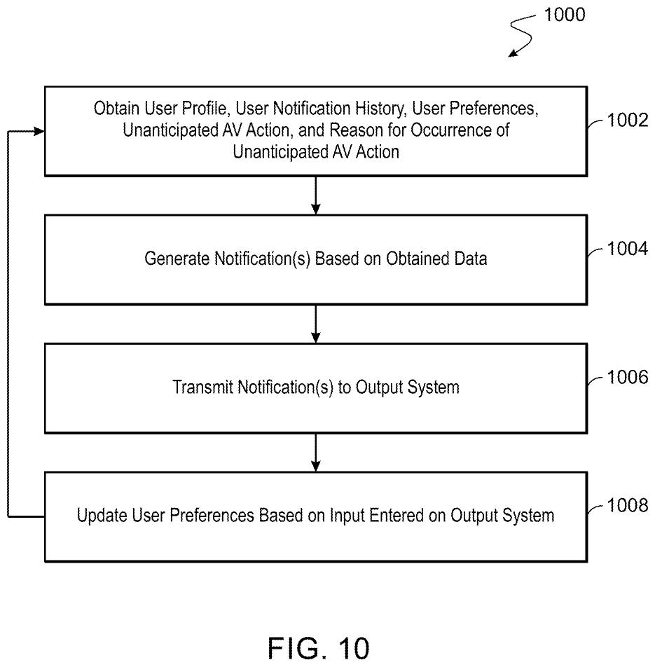

FIG. 10 is a process flow diagram of a process 1000 for outputting notifications and updating user preferences according to the present techniques. In some embodiments, one or more of the elements described with respect to process 1000 are performed (e.g., completely, partially, and/or the like) by vehicle 102 (FIG. 1), autonomous system 202 (FIG. 2), or any combinations thereof. Additionally, or alternatively, in some embodiments one or more steps described with respect to process 1000 are performed (e.g., completely, partially, and/or the like) by another device or group of devices separate from or including autonomous system 202, such as unanticipated action system 550.

At block 1002, a user profile, a user notification history, user preferences, unanticipated action, and a reason for occurrence of the unanticipated action are obtained. In some embodiments, a user notification history is a part of the user profile. In examples, one or more models output an unanticipated action. A reason for occurrence of the unanticipated action is determined via an analysis of data generated or captured by the AV at or near a timestamp associated with the unanticipated action.

At block 1004, notifications are generated based on the obtained data. In examples, the notifications are generated based on the user profile, the user notification history, or any combinations thereof. The user profile and/or the user notification history informs the generation of notifications in response to unanticipated actions. For example, a first user profile indicates that a first user expects no sudden movements (e.g., longitudinal accelerations and decelerations or turning maneuvers with forces on a passenger less than a first threshold). A second user profile indicates that a second user tolerates sudden movements above the first threshold, but below a second threshold. In an example, a notification is generated for the first user as a passenger when sudden movements occur with forces above the first threshold but below the second threshold; however for sudden movements with forces above the first threshold but below the second threshold, a notification is not generated for the second user as a passenger. At block 1006, the notifications are transmitted to the notification output system. The notification output system generates the notifications for each passenger of the AV.

At block 1008, user preferences are updated based on input to the notification output system. In some implementations, user notification history can be a part of user profile. In this manner, the present techniques includes a feedback loop. The feedback loop enables notifications to be in line with preferences specified by the user.

In some embodiments, a display of the notification output system is located within an interior of the autonomous vehicle, wherein the user is a passenger within the autonomous vehicle. This prevents surprises for passengers riding the AV, thereby allowing the passengers to develop more confidence regarding operating the AV. In some embodiments, the notification output system is located on an exterior of the autonomous vehicle. This prevents surprises for outside agents (e.g. drivers of other vehicles, pedestrians, or others on or near the trajectory), thereby allowing those outside people to develop more confidence regarding safety of the AV.

According to some non-limiting embodiments or examples, provided is a system including at least one processor and a computer-readable medium. The computer-readable medium stores instructions that, when executed by the at least one processor, cause the at least one processor to perform operations. The operations include obtaining data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving. The operations include executing a model to determine, in real-time and based on the current trajectory, the at least one constraint, and the data associated with the context, that a particular action by the autonomous vehicle is classified as an unanticipated autonomous vehicle action. Additionally, the operations include analyzing the current trajectory, the at least one constraint, and the data associated with the context within a predetermined range of time including a timestamp of the unanticipated autonomous vehicle action to determine a reason for occurrence of the unanticipated autonomous vehicle action. Further, the operations include generating, in response to the determination of the reason, a notification that includes the reason, wherein an intensity of the notification is based on, at least in part, a deviation, and transmitting data associated with the notification to a notification output system.

According to some non-limiting embodiments or examples, provided is at least one non-transitory computer-readable medium comprising one or more instructions that, when executed by at least one processor, cause the at least one processor to perform operations. The operations include obtaining data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving. The operations include executing a model to determine, in real-time and based on the current trajectory, the at least one constraint, and the data associated with the context, that a particular action by the autonomous vehicle is classified as an unanticipated autonomous vehicle action. Additionally, the operations include analyzing the current trajectory, the at least one constraint, and the data associated with the context within a predetermined range of time including a timestamp of the unanticipated autonomous vehicle action to determine a reason for occurrence of the unanticipated autonomous vehicle action. Further, the operations include generating, in response to the determination of the reason, a notification that includes the reason, wherein an intensity of the notification is based on, at least in part, a deviation, and transmitting data associated with the notification to a notification output system.

According to some non-limiting embodiments or examples, provided is a method. The method includes obtaining, with at least one processor, data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving. The method includes executing, with the at least one processor, a model to determine that a particular action by the autonomous vehicle is classified as an unanticipated autonomous vehicle action based on the current trajectory, the data associated with historical driving, and the data associated with the context, in real-time. The method also includes analyzing, with the at least one processor, the current trajectory, the at least one constraint, and the data associated with the context within a predetermined range of time including a timestamp of the unanticipated autonomous vehicle action to determine a reason for occurrence of the unanticipated autonomous vehicle action. Further, the method includes generating, with the at least one processor, a notification that includes the reason, wherein an intensity of the notification is based on, at least in part, a deviation, and transmitting, with the at least one processor, data associated with the notification to a notification output system.

Further non-limiting aspects or embodiments are set forth in the following numbered clauses:

Clause 1: A system comprising: at least one processor; and a computer-readable medium storing instructions that, when executed by the at least one processor, cause the at least one processor to perform operations comprising: obtaining data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving; executing a model to determine, in real-time and based on the current trajectory, the data associated with historical driving, and the data associated with the context, that a particular action by the autonomous vehicle is classified as an unanticipated autonomous vehicle action; analyzing the current trajectory, the at least one constraint, and the data associated with the context within a predetermined range of time including a timestamp of the unanticipated autonomous vehicle action to determine a reason for occurrence of the unanticipated autonomous vehicle action; generating, in response to the determination of the reason, a notification that includes the reason, wherein an intensity of the notification is based on, at least in part, a deviation; and transmitting data associated with the notification to a notification output system.

Clause 2: The system of clause 1, wherein the model is a machine learning model trained to output unanticipated autonomous vehicle actions.

Clause 3: The system of any of clauses 1 or 2, wherein the at least one constraint comprises at least one object within a predetermined range of the autonomous vehicle.

Clause 4: The system of clause 3, wherein the at least one object comprises a pedestrian or another vehicle located in the current trajectory of the autonomous vehicle.

Clause 5: The system of any of clauses 1-4, wherein the data associated with the context comprises one or more of a semantic map, localization data, or perception data.

Clause 6: The system of any of clauses 1-5, wherein generating the notification comprises generating a first notification and a second notification simultaneously, wherein the first notification captures a user response at the predetermined range of time of the notification, and the second notification comprises an explanation of the unanticipated action.

Clause 7: The system of any of clauses 1-6, wherein generating the notification comprises: obtaining data associated with a profile of the user, a notification history of the user, and notification preferences of the user; and generating the notification in accordance with the data associated with a profile of the user, the notification history, and the notification preferences.

Clause 8: The system of clause 7, wherein the operations further comprise: receiving an input indicating a preference of the user for future notifications; updating the data indicating the notification preferences with the input; and generating notifications in accordance with the updated data indicating the notification preferences.

Clause 9: The system of any of clauses 1-8, wherein the notification output system is located within an interior of the autonomous vehicle, wherein the user is a passenger within the autonomous vehicle.

Clause 10: The system of any of clauses 1-9, wherein the notification output system is located on an exterior of the autonomous vehicle.

Clause 11: The system of any of clauses 1-10, wherein the notification output system is configured to output the notification.

Clause 12: A non-transitory computer readable medium comprising one or more instructions that, when executed by at least one processor, cause the at least one processor to perform operations comprising: obtaining data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving; executing a model to determine, in real-time and based on the current trajectory, the data associated with historical driving, and the data associated with the context, that a particular action by the autonomous vehicle is classified as an unanticipated autonomous vehicle action; analyzing the current trajectory, the at least one constraint, and the data associated with the context within a predetermined range of time including a timestamp of the unanticipated autonomous vehicle action to determine a reason for occurrence of the unanticipated autonomous vehicle action; generating, in response to the determination of the reason, a notification that includes the reason, wherein an intensity of the notification is based on, at least in part, a deviation; and transmitting data associated with the notification to a notification output system.

Clause 13: The non-transitory computer readable medium of clause 12, wherein the model is a machine learning model trained to output unanticipated autonomous vehicle actions.

Clause 14: The non-transitory computer readable medium of any of clauses 12 or 13, wherein the at least one constraint comprises at least one object within a predetermined range of the autonomous vehicle.

Clause 15: A method comprising: obtaining, with at least one processor, data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving; executing, with the at least one processor, a model to determine that a particular action by the autonomous vehicle is classified as an unanticipated autonomous vehicle action based on the current trajectory, the data associated with historical driving, and the data associated with the context, in real-time; analyzing, with the at least one processor, the current trajectory, the at least one constraint, and the data associated with the context within a predetermined range of time including a timestamp of the unanticipated autonomous vehicle action to determine a reason for occurrence of the unanticipated autonomous vehicle action; generating, with the at least one processor, a notification that includes the reason, wherein an intensity of the notification is based on, at least in part, a deviation; and transmitting, with the at least one processor, data associated with the notification to a notification output system.

Clause 16: The method of clause 15, wherein the model is a machine learning model trained to output unanticipated autonomous vehicle actions.

Clause 17: The method of any of clauses 15 or 16, wherein the at least one constraint comprises at least one object within a predetermined range of the autonomous vehicle.

Clause 18: The method of clause 17, wherein the at least one object comprises a pedestrian or another vehicle located in the current trajectory of the autonomous vehicle.

Clause 19: The method of any of clauses 15-18, wherein the data associated with the context comprises one or more of a semantic map, localization data, or perception data.

Clause 20: The method of any of clauses 15-19, wherein generating the notification comprises generating a first notification and a second notification simultaneously, wherein the first notification captures a user response at the predetermined range of time of the notification, and the second notification comprises an explanation of the unanticipated action.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A system comprising:
at least one processor; and
a computer-readable medium storing instructions that, when executed by the at least one processor, cause the at least one processor to perform operations comprising:
obtaining data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving;
executing a model to determine, in real-time and based on the current trajectory, the data associated with historical driving, and the data associated with the context, that a particular action by the autonomous vehicle is classified as an unanticipated autonomous vehicle action;
analyzing the current trajectory, the at least one constraint, and the data associated with the context within a predetermined range of time including a timestamp of the unanticipated autonomous vehicle action to determine a reason for occurrence of the unanticipated autonomous vehicle action;
generating, in response to the determination of the reason, a notification that includes the reason, wherein an intensity of the notification is based on, at least in part, a deviation; and
transmitting data associated with the notification to a notification output system.

2. The system of claim 1, wherein the model is a machine learning model trained to output unanticipated autonomous vehicle actions.

3. The system of claim 1, wherein the at least one constraint comprises at least one object within a predetermined range of the autonomous vehicle.

4. The system of claim 3, wherein the at least one object comprises a pedestrian or another vehicle located in the current trajectory of the autonomous vehicle.

5. The system of claim 1, wherein the data associated with the context comprises one or more of a semantic map, localization data, or perception data.

6. The system of claim 1, wherein generating the notification comprises generating a first notification and a second notification simultaneously, wherein the first notification captures a user response at the predetermined range of time of the notification, and the second notification comprises an explanation of the unanticipated action.

7. The system of claim 1, wherein generating the notification comprises:
obtaining data associated with a profile of the user, a notification history of the user, and notification preferences of the user; and
generating the notification in accordance with the data associated with a profile of the user, the notification history, and the notification preferences.

8. The system of claim 7, wherein the operations further comprise:
receiving an input indicating a preference of the user for future notifications;
updating the data indicating the notification preferences with the input; and
generating notifications in accordance with the updated data indicating the notification preferences.

9. The system of claim 1, wherein the notification output system is located within an interior of the autonomous vehicle, wherein the user is a passenger within the autonomous vehicle.

10. The system of claim 1, wherein the notification output system is located on an exterior of the autonomous vehicle.

11. The system of claim 1, wherein the notification output system is configured to output the notification.

12. A non-transitory computer readable medium comprising one or more instructions that, when executed by at least one processor, cause the at least one processor to perform operations comprising:
obtaining data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving;
executing a model to determine, in real-time and based on the current trajectory, the data associated with historical driving, and the data associated with the context, that a particular action by the autonomous vehicle is classified as an unanticipated autonomous vehicle action;
analyzing the current trajectory, the at least one constraint, and the data associated with the context within a predetermined range of time including a timestamp of the unanticipated autonomous vehicle action to determine a reason for occurrence of the unanticipated autonomous vehicle action;
generating, in response to the determination of the reason, a notification that includes the reason, wherein an intensity of the notification is based on, at least in part, a deviation; and
transmitting data associated with the notification to a notification output system.

13. The non-transitory computer readable medium of claim 12, wherein the model is a machine learning model trained to output unanticipated autonomous vehicle actions.

14. The non-transitory computer readable medium of claim 12, wherein the at least one constraint comprises at least one object within a predetermined range of the autonomous vehicle.

15. A method comprising:
obtaining, with at least one processor, data associated with a current trajectory of an autonomous vehicle, at least one constraint, data associated with historical driving for a user using the autonomous vehicle from an expectation database, and data associated with a context that represents a relationship between the current trajectory, at least one constraint, and the data associated with historical driving;
executing, with the at least one processor, a model to determine that a particular action by the autonomous vehicle is classified as an unanticipated autonomous vehicle action based on the current trajectory, the data associated with historical driving, and the data associated with the context, in real-time;
analyzing, with the at least one processor, the current trajectory, the at least one constraint, and the data associated with the context within a predetermined range of time including a timestamp of the unanticipated autonomous vehicle action to determine a reason for occurrence of the unanticipated autonomous vehicle action;
generating, with the at least one processor, a notification that includes the reason, wherein an intensity of the notification is based on, at least in part, a deviation; and
transmitting, with the at least one processor, data associated with the notification to a notification output system.

16. The method of claim 15, wherein the model is a machine learning model trained to output unanticipated autonomous vehicle actions.

17. The method of claim 15, wherein the at least one constraint comprises at least one object within a predetermined range of the autonomous vehicle.

18. The method of claim 17, wherein the at least one object comprises a pedestrian or another vehicle located in the current trajectory of the autonomous vehicle.

19. The method of claim 15, wherein the data associated with the context comprises one or more of a semantic map, localization data, or perception data.

20. The method of claim 15, wherein generating the notification comprises generating a first notification and a second notification simultaneously, wherein the first notification captures a user response at the predetermined range of time of the notification, and the second notification comprises an explanation of the unanticipated action.
